(19) United States
(12) Patent Application Publication
(10) Pub. No.: US 2013/0306456 A1
(43) Pub. Date: Nov. 21, 2013

(54) ELECTRONIC DEVICE

(71) Applicant: HON HAI PRECISION INDUSTRY CO., LTD., New Taipei (TW)

(72) Inventors: YEN-WEN WANG, New Taipei (TW); YONG-JUN YU, Shenzhen (CN); XUE-FENG WAN, Shenzhen (CN)

(73) Assignee: HON HAI PRECISION INDUSTRY CO., LTD., New Taipei (TW)

(21) Appl. No.: 13/855,717

(22) Filed: Apr. 3, 2013

(30) Foreign Application Priority Data
May 15, 2012 (CN) 201210149640.X

(51) Int. Cl. H01H 13/86

(52) U.S. Cl. CPC H01H 13/86
USPC 200/5 A

(57) ABSTRACT

An electronic device includes a housing, a number of keys and a keypad fixed on an inner surface of the housing under the keys. The PCB includes a plurality of edges, a plurality of cutouts having one is defined in a first edge of the edges, and a plurality of bolt holes having one is arranged adjacent to a second edge of the edges. A bolt extends through the bolt hole and threaded engaged with the housing. The housing further includes a plurality of holders arranged on the inner surface of the housing, each holder includes a first retaining plate and a second retaining plate, the first retaining plate is accommodated in the corresponding cutout and the second retaining plate resists against the keypad to prevent the keypad from disengaging from the holder.

### BACKGROUND

1. Technical Field

The present disclosure relates to electronic devices, and particularly to an electronic device with a keypad (printed circuit board).

2. Description of Related Art

Some electronic devices employ a keyboard or a number of buttons to input information. Usually, a keypad is arranged under the keyboard or the buttons. The keypad includes a number of contact pads arranged on a surface of the keypad in correspondence with the keys or buttons and can be actuated by the keys or buttons.

Referring to FIG. 7, a keypad 400 is fixed on an inner surface of a housing 300. The keypad 400 is shaped like a rectangle, and several bolts 500 are located on each edges of the keypad 400 to fix the keypad 400 on the housing 300. Nine bolts 500 are used to fix the keypad 400, eight bolts 500 are located on the four edges of the keypad 400, and the other one bolt 500 is located on the central of the keypad 400. The using of the large number of bolts 500 may result in that the assembly becomes complicated and the cost increases. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, schematic view of an electronic device in accordance with an exemplary embodiment.

FIG. 2 is a schematic, rear view of an upper housing of the electronic device of FIG. 1.

FIG. 3 is schematic view showing a keypad of the electronic device of FIG. 1.

FIG. 4 is an assembly view showing the keypad of the electronic device of FIG. 1.

FIG. 5 is a schematic view showing the partial enlarged detail of the encircled portion I of FIG. 2.

FIG. 6 is a schematic view showing the partial enlarged detail of the encircled portion II of FIG. 2.

FIG. 7 is an assembly view showing a keypad in accordance with a related art.

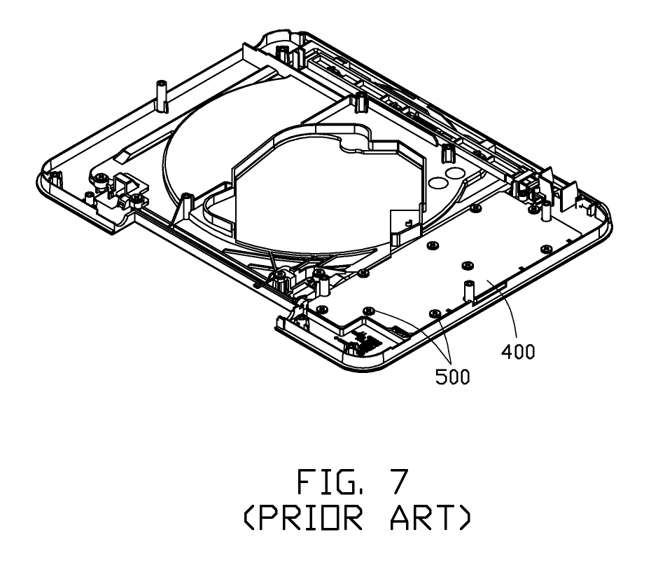

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean at least one.

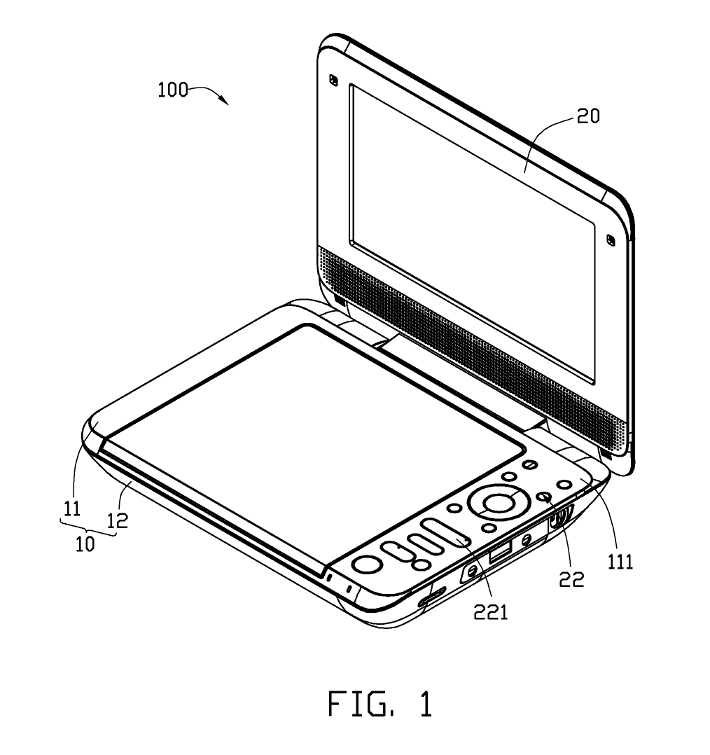

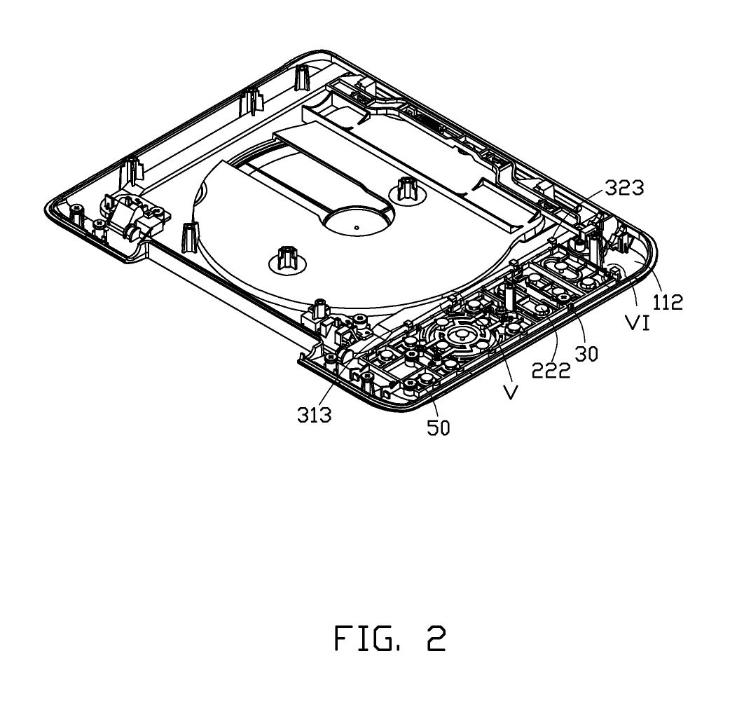

Referring to FIGS. 1 and 2, an electronic device 100 includes a base 10 and a cover 20 rotatably connected to the base 10 via a hinge (not labeled). The base 10 includes an upper housing 11, a lower housing 12, and a number of keys 22. Each of the keys 22 includes a top portion 221 and a bottom portion 222, and the top portion 221 passes through an cutout (not labeled) of the upper housing 11 and is exposed to an outedge of the housing 11 for being pressed by a user. In the embodiment, the electronic device 10 is a portable DVD player, and the cover 20 includes a display screen facing the base 10.

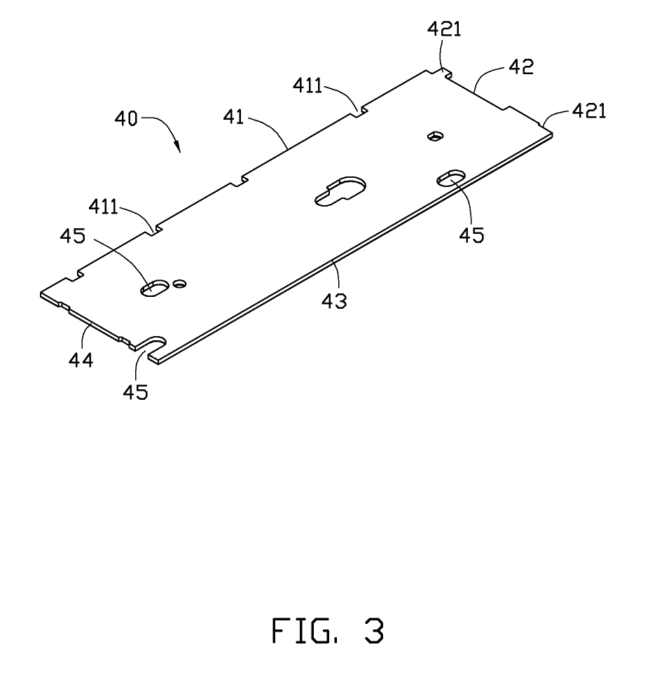

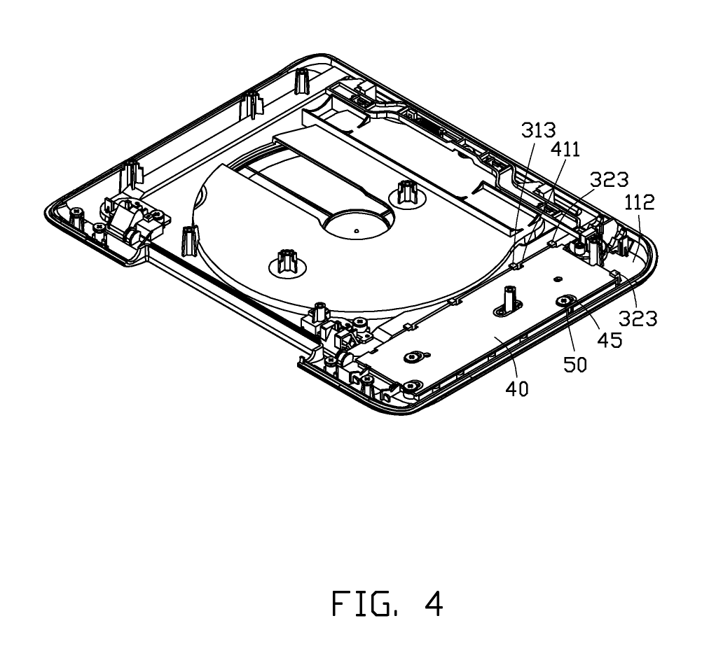

Referring to FIGS. 3 and 4, a keypad 40 is fixed on an inner surface 112 of the upper housing 11 and located under the keys 22. The keypad 40 includes a number of contact pads (not shown) arranged on a surface of the keypad 40 in correspondence with the keys 22. A user can press the top portion 221 of the key 22 to push the contact pad of the keypad 40, causing the keypad 40 to generate a signal and send the signal to the control unit of the electronic device 100.

In the embodiment, the keypad 40 is shaped like a rectangle, and includes a fist edge 41, a second edge 42 adjoining the fist edge 41, a third edge 43 opposite the fist edge 41, and a fourth edge 44 opposite the second edge 42. At least one first cutout 411 is defined in the first edge 41 of the keypad 40, at least one second cutout 421 is defined in the second edge 42, at least one bolt hole 45 is defined in the third edge 43, and at least one bolt hole 45 is defined in the fourth edge 44.

At least one first holder 313 is arranged on the inner surface 112 of the upper housing 11 in correspondence with the first cutout 411 of the keypad 40. At least one second holder 323 is arranged on the inner surface 112 of the upper housing 11 in correspondence with the second cutout 421. At least one screwed hole 30 is defined in the inner surface 112 of the upper housing 11 and aligned with the bolt holes 45 of the keypad 40. A bolt 50 extends through the bolt hole 45 and is screwed into the screwed hole 30 to fix the keypad 40 and the upper housing 11 together.

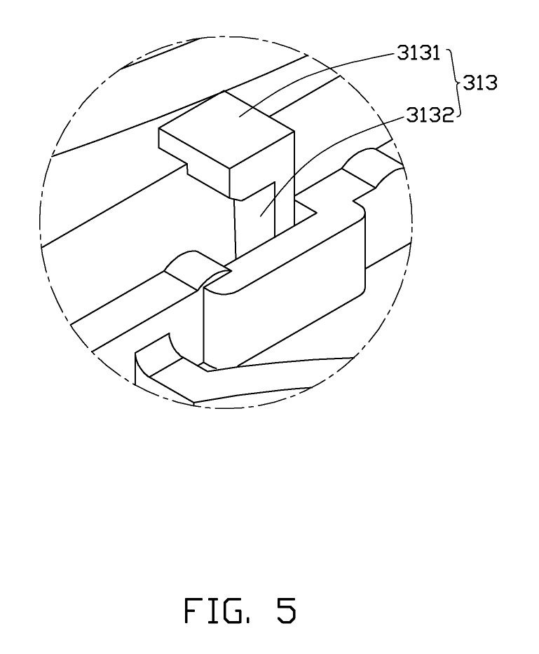

Referring to FIG. 5, each of the first holder 313 includes a first retaining plate 3131 and a second retaining plate 3132 perpendicular to the first retaining plate 3131. The first retaining plate 3131 is parallel to the inner surface 112 of the upper housing 11, and the second retaining plate 3132 is perpendicular to the inner surface 112 of the upper housing 11. In the embodiment, the number of the first holder 313 is three, and the three first holders 313 are arranged in a line.

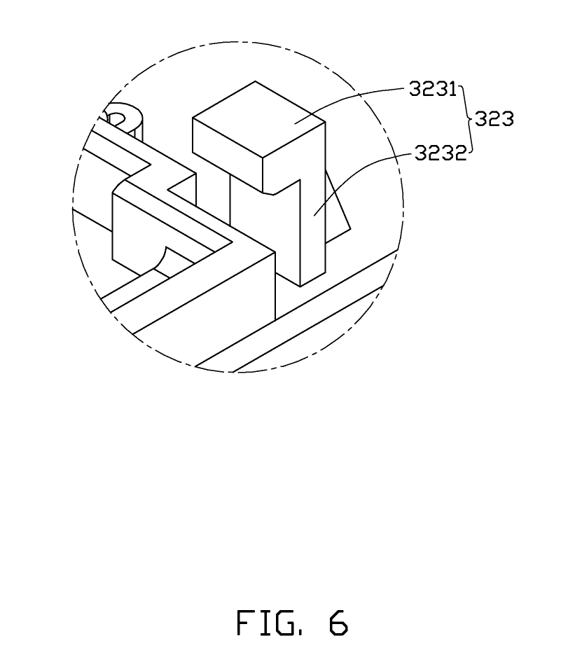

Referring to FIG. 6, each of the second holder 323 includes a third retaining plate 3231 parallel to the inner surface 112 of the upper housing 11, and a fourth retaining plate 3232 perpendicular to the inner surface 112 of the upper housing 11. In the embodiment, the number of the second holder 323 is two.

During assembly, the keypad 40 is assembled on the inner surface 112 of the upper housing 11, the second retaining plates 3132 of the first holders 313 are accommodated in the first cutouts 411, and the fourth retaining plates 3232 of the second holders 323 are accommodated in the second cutouts 421. The operator then just needs to screw the bolts 50 into the screwed hole 30.

The second retaining plate 3132 and the fourth retaining plate 3232 hold the keypad 40 on the inner surface 112 of the upper housing 11 along the direction of the first edge 41 and the second edge 42. The first retaining plate 3131 and the third retaining plate 3231 resist against the keypad to prevent the keypad 40 from disengaging from the holder 313 and 323. The keypad 40 is fixed on the inner surface 112 of the upper housing 11 by the first holder 313, the second holder 323 and the blots 50. Compared with that the keypad 40 is fixed on the inner surface 112 by bolts, the above described structure has an advantage of using fewer bolts 50. Therefore, the assembly becomes more convenient and the cost can be decreased.

Referring again to FIG. 3, in this embodiment, a bolt hole 45 can be defined in the central of the keypad 40, and a screwed hole 30 is also defined in the inner surface 112 of the upper housing 11 and is aligned with the bolt hole 45.

In other embodiments, the keypad 40 may only include at least one bolt hole 45 in the third edge 43.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electronic device comprising:
a housing;
a plurality of keys accommodated in the housing and each of the keys comprising a top portion exposed to an outedge of the housing;
a keypad fixed on an inner surface of the housing, and located under the keys, the keypad comprising a plurality of edges, a plurality of cutouts having one defined in a first edge of the edges, and a plurality of bolt holes having one arranged adjacent to a second edge of the edges;
a bolt extending through the bolt hole and threaded engaged with the housing;
wherein the housing further comprises a plurality of holders arranged on the inner surface of the housing, each holder comprises a first retaining plate and a second retaining plate, the first retaining plate is accommodated in the corresponding cutout and the second retaining plate resists against the keypad to prevent the keypad from disengaging from the holder.

2. The electronic device of claim 1, wherein the keypad is rectangular, and the edges comprises a first edge, a second edge adjoining the first edge, a third edge opposite to the first edge and a fourth edge opposite to the second edge, the cutouts include another one defined in the second edge.

3. The electronic device of claim 2, wherein the bolt holes include another one arranged adjacent to the third edge.

4. The electronic device of claim 2, wherein the bolt holes include two another holes respectively arranged adjacent to the third edges and the fourth edge.

5. The electronic device of claim 2, wherein the bolt holes include another one defined in a central portion of the keypad.
